(19) United States
(12) Patent Application Publication
(10) Pub. No.: US 2003/0142136 A1
(43) Pub. Date: Jul. 31, 2003

(54) Three dimensional graphical user interface

(76) Inventors: Braxton Page Carter, San Diego, CA (US); Christiann Grace Moore, San Diego, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/293,173

(22) Filed: Nov. 13, 2002

Related U.S. Application Data
(60) Provisional application No. 60/333,401, filed on Nov. 26, 2001.

(51) Int. Cl. G09G 5/00

(52) U.S. Cl. 345/782

(57) ABSTRACT

A system and method for displaying a desktop workspace of greater effective area than that of the display screen using Non-uniform Rational B-Splines (NURBS) surface planes employing real-time texture mapping. A 3D Desktop GUI based on NURBS allows a user to Manage shortcut icons, files, hard disks in a three-dimensional world having a plurality of objects provides enhanced navigational capabilities. In addition, the 3D Desktop allows the user to seek to an object or location in the NURB world, navigate throughout the world using cursor inputs and select an object to follow links associated with that object. When an object is selected from the NURB surface, a 3D file cabinet is displayed showing the contents associated with the object. Selecting a document from within the 3D filing cabinet displays the document in a preview page which also enables a user to launch the native application for the document.

### CROSS-REFERENCE TO RELATED APPLICATIONS

This application claims the benefit of U.S. Provisional Application No. 60/333,401, filed Nov. 26, 2001.

### REFERENCE TO COMPUTER PROGRAM LISTING APPENDIX

Incorporated herein by reference is a Computer Program Listing Appendix. The Computer Program Listing Appendix is included on two copies of a compact disc in accordance with 37 CFR1.96(c)(2), 37 CFR 1.52(e), and MPEP 608.05. Each compact disc is labeled as follow: Inventors Braxton, Carter, and Christiann Moore; Title of Invention: Three Dimensional Graphical User Interface; Attorney Docket no. 76380/25135; created Nov. 13, 2002; the first copy is labeled “Copy 1” and the second copy is labeled “Copy 2”. Each compact disc includes a single file having a filename of “3ddd_nurbs.cpp”, which was created on Nov. 13, 2002 at 6:31 AM and has a file size of 35,308 bytes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention relates generally to graphical user interfaces (“GUI”) for computer systems, and more particularly to computer system GUIs that permit a user to utilize a workspace having a greater effective area than that permitted by the two dimensional display area of a display screen.

In a typical computer system, a user interacts with the system via various input devices, such as a keyboard and mouse, and various output devices, usually comprising a video display terminal having a screen for displaying images and text. In operation, the computer system executes a computer program called the operating system, (“OS”) which allows the user, as well as other programs, to control the computer system. An OS includes a user interface (“UI”) which allows a user to communicate with and control the OS.

The various schemes for implementing UIs are categorized by the manner in which the user interacts with the system. For example, a character user interface (ChUI), such as DOS, controls an OS through text commands input by a user, generally via a keyboard. In response, the OS returns text messages to be displayed on a screen or video display terminal. However, in a GUI, such as Microsoft Windows XP and Macintosh OS X, a user suitably interacts with the system by manipulating graphical objects on a display screen. The display of a typical GUI comprises at least one window, which is a framed user workspace that can be manipulated independently of the portion of the display screen outside the frame. Windows generally contain objects, or icons, which represent various commands, applications, and the like. While a typical GUI display comprises two-dimensional objects such as the above-described windows and icons, a number of user interfaces have been developed that employ three-dimensional constructs.

When the user opens or executes a icon in a typical GUI (e.g., in Windows XP, by double-clicking the mouse button while the cursor is positioned on the icon), the command represented by the icon is executed. Generally, an icon represents an application, which is launched when the command is executed. As a user adds more applications to the desktop more icons are required. At some point, the number of icons exceeds the available display space. In response, a number of strategies for increasing display space have been implemented.

One such strategy is to utilize scrollable windows. Horizontal and/or vertical scroll bars are provided to scroll the workspace past the window, thereby enabling the user to look at different portions of the workspace. Another such strategy is to provide multiple windows, each containing a portion of the total set of icons. The user suitably views different icons by selecting different windows. But because the windows must eventually overlap due to limited display space, a user can see only a portion of the total set of icons at any given time.

The drawback to the prior art schemes is that icons are organized in two-dimensional windows, whether or not the two-dimensional windows. It would therefore be preferable if a user were able to view and manipulate icons as one would in three-dimensional space so that a user is capable of viewing a larger number of icons simultaneously.

### SUMMARY OF THE INVENTION

The present invention enables a computer system having a GUI to display three dimensional objects with icons mapped thereto. In the preferred embodiment, the three dimensional objects for displaying icons are Non-uniform Rational B-Splines (“NURBS”) surfaces. The texture mapped NURBS surface planes are then displayed at respective orientations to form a NURBS cube or other three dimensional objects, which thereby appears to be comprised of a number of faces, each of which has a window. Thus, depending on the orientation of the object, a user can view one or more windows simultaneously.

One aspect of the present invention is a graphical user interface system for simultaneously displaying a plurality of windows, comprising a plurality of Non-uniform Rational B-Splines surface planes, each surface plane having a window texture mapped thereon; and display means for displaying said surface planes at respective orientations. The Non-uniform Rational B-Splines surface planes may form a polyhedron such as a cube. Using input means for receiving user input causes the display means to display more than one of said surfaces simultaneously.

In the preferred embodiment, the system further comprises either an icon, an applet, or a combination thereof mapped to a one of the plurality of surface planes. When either an icon or applet is selected, a plurality of objects are displayed in a 3D File cabinet. The 3D File cabinet further comprises a representation of a document, wherein selection of the representation causes the document to be displayed in a preview window. The preview window further comprises means for launching an application associated with said document.

Another aspect of the present invention is a computer-readable medium of instructions, comprising means for creating a plurality of Non-uniform Rational B-Splines surface planes, each surface plane having a window texture mapped thereon; and means for displaying said surface planes at respective orientations. Additional instructions may be implemented for the Non-uniform Rational B-Splines surface planes to form a polyhedron. The instructions may further comprising means for receiving user input, causing more than one of surfaces to be displayed simultaneously, or means for rotating the a Non-uniform Rational B-Splines surface planes in response to a user input. In a preferred embodiment of this aspect, The instructions further comprise means for displaying a plurality of objects in a 3D File cabinet that is displayed when an object is selected from one of the surface planes, the object may be either an icon or an applet. When a document is selected from the 3D File cabinet, means for displaying a representation of a document displays the document in a preview window. The preview window having means for launching an application associated with said document.

Yet another aspect of the present invention is a method for displaying icons on a graphical user interface comprising the steps of texture mapping a plurality of windows to a plurality of Non-uniform Rational B-Splines surface planes; and displaying said surface planes at respective orientations. The method may further comprise orientating the Non-uniform Rational B-Splines surface planes to form a polyhedron, such as a cube. The method may further include receiving user input and responding to the user input by displaying more than one of the surfaces simultaneously.

In the preferred embodiment of the method, the method further comprises either an icon, applet, or combinations thereof to the surface planes. Upon selection of the icon or applet, a 3D file cabinet displaying a plurality of documents is displayed on the screen. Upon selection of one of the documents, a representation of a document is displayed in a preview window. An application associated with the document is launched by selecting an icon from the preview window.

Still other objects of the present invention will become readily apparent to those skilled inn this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### DESCRIPTION OF THE FIGURES

FIG. 1 is an example of a typical prior art GUI;

FIG. 2 is an exemplary GUI organization structure according to the present invention;

FIGS. 3A and 3B partial views of a three-dimensional display of the type utilized in the present invention;

FIG. 4 depicts a NURBS cube; and

FIGS. 5A and 5B depict one view of a three-dimensional GUI of the present invention according to a preferred embodiment;

FIGS. 6A-6D depict additional views of a three-dimensional GUI of the present invention according to a preferred embodiment;

FIG. 7 depicts an exemplary view of a three dimensional (3D) filing cabinet;

FIG. 8 is an exemplary view of the 3D filing cabinet superimposed on a cube surface;

FIG. 9 is an example of the 3D filing cabinet with a large number of documents stored therein;

FIGS. 10 and 10a illustrate an example of the 3D filing cabinet with a plurality of planes illustrating how the documents may be dragged outside of the filing cabinet;

FIG. 11 is an example of the 3D filing cabinet wherein the filing cabinet drawer is larger than the frame of the filing cabinet;

FIG. 12 is an example of the 3D filing cabinet with more than one drawer is open;

FIG. 13 is an illustration showing an example of a filing cabinet with a lockable drawer option;

FIG. 14 is an example of the 3D filing cabinet illustrating a document being removed from the drawer;

FIG. 15 is a top view of a 3D filing cabinet wherein the documents may be extended from the cabinet along the positive and negative x axis and the positive and negative y axis;

FIG. 16 is an isometric view of the 3D filing cabinet showing documents extending from the cabinet along the x, y and z axis; and

FIG. 17 is an example of a document displayed in a preview window.

### DETAILED DESCRIPTION OF THE INVENTION

The preferred embodiment of the invention is discussed in detail below. While specific steps, configurations and arrangements are discussed, it should be understood that this is done for illustrative purposes only. A person skilled in the relevant art will recognize that other steps, configurations and arrangements can be used without departing from the spirit and scope of the invention.

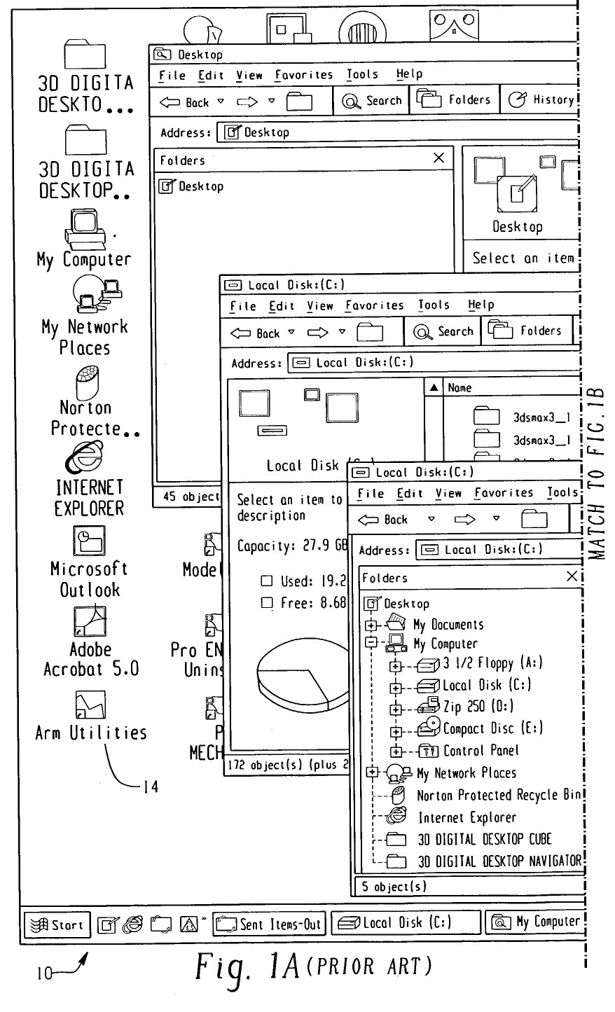

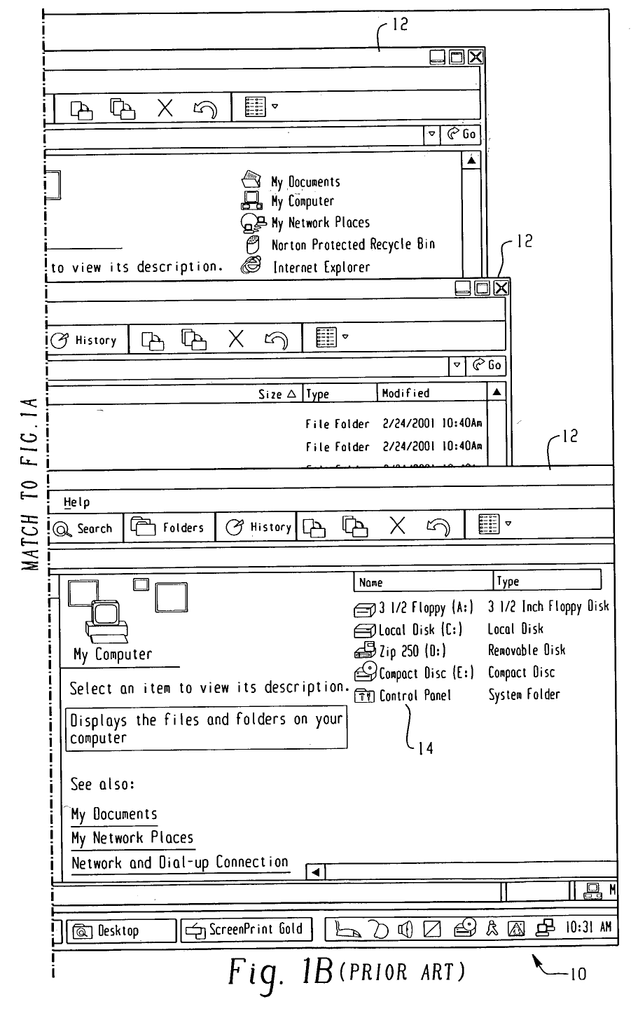

Turning now to FIG. 1, a typical prior art GUI is displayed. A display screen is filled with a background 10 (otherwise known as a desktop 10). Superimposed on desktop 10 are a number of rectangular graphical objects referred to as windows 12. A window 12 is a framed user workspace which can be manipulated independently of that portion of the display screen outside the frame. For example, a window in a word processing application suitably contains the text of a document the user is editing, or a window in a drawing application suitably contains the figure the user is drawing. A window belonging to a computer OS suitably contains icons 14. Superimposed on desktop 10 are a number of windows 12, each containing a number of icons 14. Typically, each icon 14 represents a command that the user suitably executes by double-clicking on icon 14 using a mouse button. In the preferred embodiment, each icon 14 represents an application, which is launched by executing the command represented by the icon. With the prior art GUI as shown in FIG. 1, the user experiences difficulty locating icons 14 and therefore experiences difficulty executing commands because many icons 14 are not readily visible because the windows 12 overlap. Even if all of the icons 14 were transferred to a single window, there are simply more icons than can be displayed simultaneously in the available space on the display. It would therefore be preferable if there existed a method for viewing all icons 14 simultaneously.

Accordingly, the present invention seeks to provide a three-dimensional space for the placement of icons 14 such that more icons 14 are viewable simultaneously than would be possible utilizing a desktop having overlapping windows. One method of creating a three-dimensional space for the placement of icons 14 is utilize Non-uniform Rational B-Splines (“NURBS”). NURBS are tools that can be used for the representation and design of geometry. In the presently preferred embodiment, NURBS are utilized to design a three-dimensional desktop. Advantages to utilizing NURBS as opposed to alternative techniques are as follows: NURBS offer one common mathematical form for both, standard analytical shapes (e.g. conics) and free form shapes; NURBS provide the flexibility to design a large variety of shapes; NURBS can be evaluated reasonably fast by numerically stable and accurate algorithms; NURBS are invariant under affine as well as perspective transformations; and NURBS are generalizations of non-rational B-splines and non-rational and rational Bezier curves and surfaces.

One advantage NURBS have, is a flexibility in defining parametric shapes. NURBS-shapes are not only defined by control points, but also by weights associated with each control point. A NURBS curve C(u), for example, is a vector-valued piecewise rational polynomial function, and is suitably defined as:

$$C ( u ) = \frac{sum ( i = 0 , n ) \{ w\_i * P\_i * N\_i , k ( u ) \}}{sum ( i = 0 , n ) \{ w\_i * N\_i , k ( u ) \}} , \qquad ( 1 )$$

where

w_i: weights

P_i: control points (vector)

N_i,k: normalized B-spline basis functions of degree k

These B-splines are suitably defined recursively as:

$$N\_i , k ( u ) = \frac{u - t\_i}{t\_i + k - t\_I} * N\_i , k - 1 ( u ) + \frac{t\_i + k + 1 - u}{t\_i + k + 1 - t\_i + 1} * N\_i + 1 , k - 1 ( u ) \qquad ( 2 )$$

and

/1, if t_{—}i<=u<t_{—}i+1

N_{—}i,0(u)=<0

\0, else

where t_i are the knots forming a knot vector

U={t_{—}0, t_{—}1, . . . , t_{—}m}.

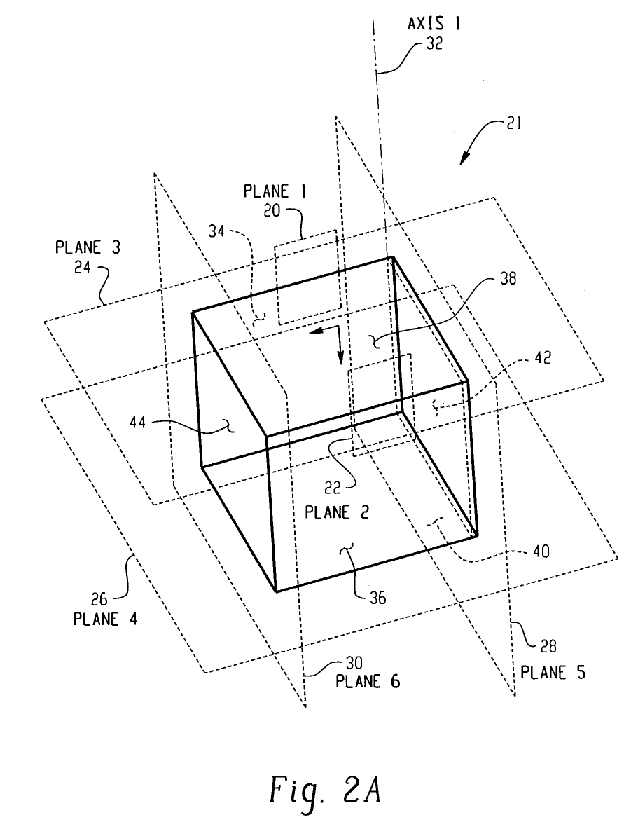

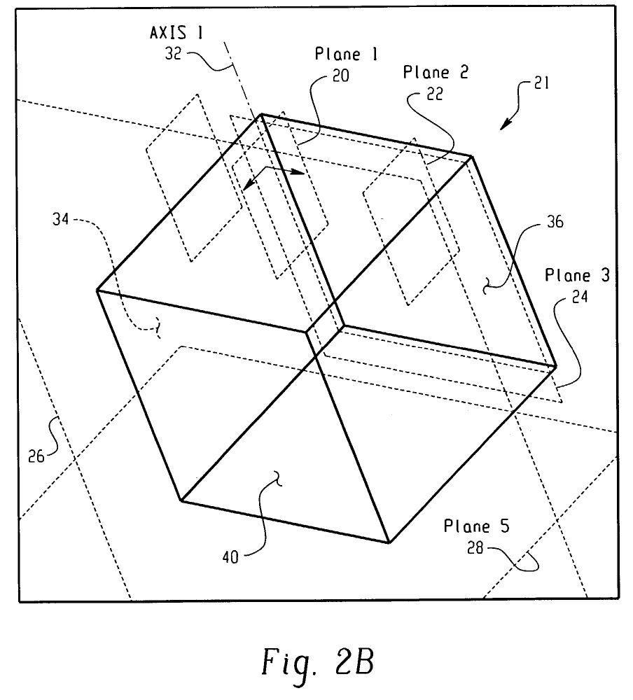

Turning now to FIGS. 2A and 2B, a NURBS cube of the type utilized in the present invention is displayed. The NURBS cube 21 suitably occupies a first plane 20 generally parallel to second plane 22, and third plane 24 generally parallel to forth plane 26, wherein both the third plane 24 and forth plane 26 are generally orthogonal to first plane 20 and second plane 22. The cube 21 also occupies a fifth plane 28 generally parallel to sixth plane 30 wherein the fifth plane 28 and sixth plane 30 are generally orthogonal to first plane 20, second plane 22, third plane 24 and forth plane 26.

The cube 21 suitably has six sides, each of which has an inside or interior face and an outside or exterior face. First side 34 resides in first plane 20, second side 36 resides in second plane 22, third side 38 resides in third plane 24, forth side 40 resides in forth plane 26, fifth side 42 resides in fifth plane 28, and sixth side 44 resides in sixth plane 30. The six sides are suitably the same shape and size or varying in sizes. According to a presently preferred embodiment of the present invention, up to twelve workspaces are suitably displayed simultaneously, one on each face (inside and outside) of each of six sides of rotating cube 21. The workspaces are preferably translucent such that all twelve workspaces are visible to a user simultaneously. In addition, the three-dimensional cube is suitably rotatable about at least one axis, and preferably about three axes.

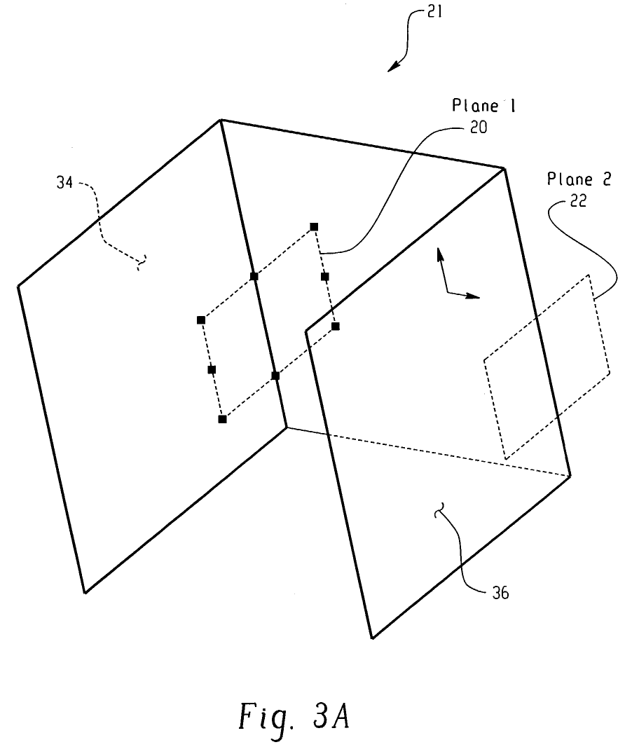

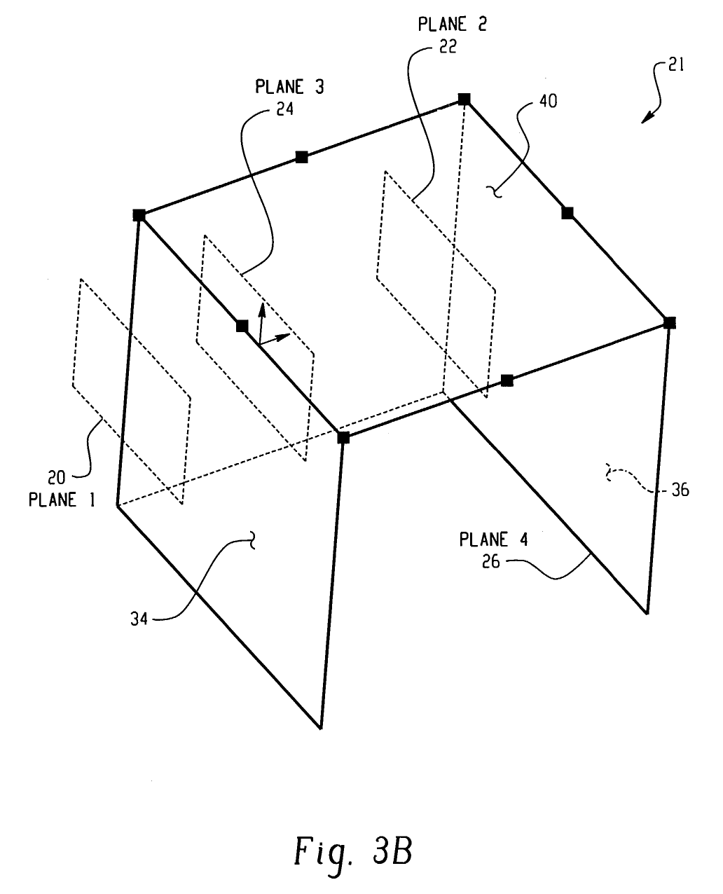

Turning now to FIGS. 3A and 3B, partial cubes 21 are displayed to illustrate how positions are located in the cube.

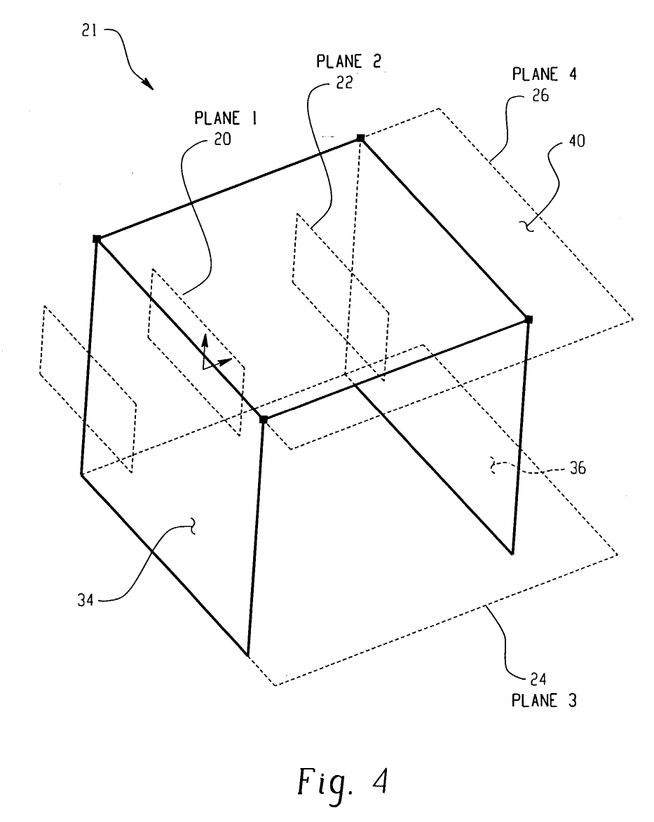

Turning next to FIG. 4, another partial cube 21 for texture mapping is shown. In a presently preferred embodiment of the present invention, windows or desktop surfaces are applied to the faces (interior or exterior) of the cube by a process known as “texture mapping,” which is the application of an image to the surface of a displayed object. Therefore, when the cube rotates, the texture mapping is suitably executed in real time such that the texture mapping rotates with the cube.

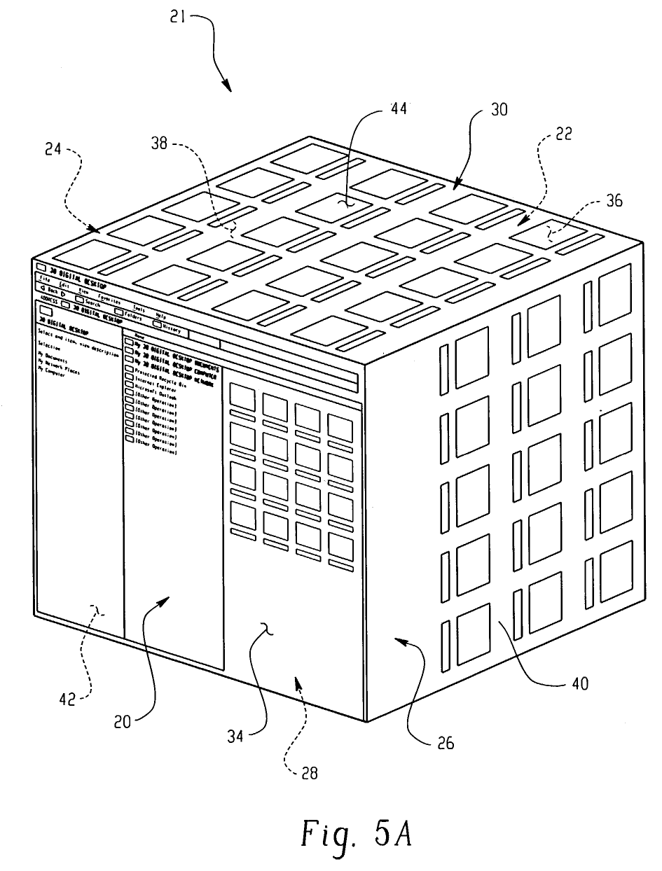

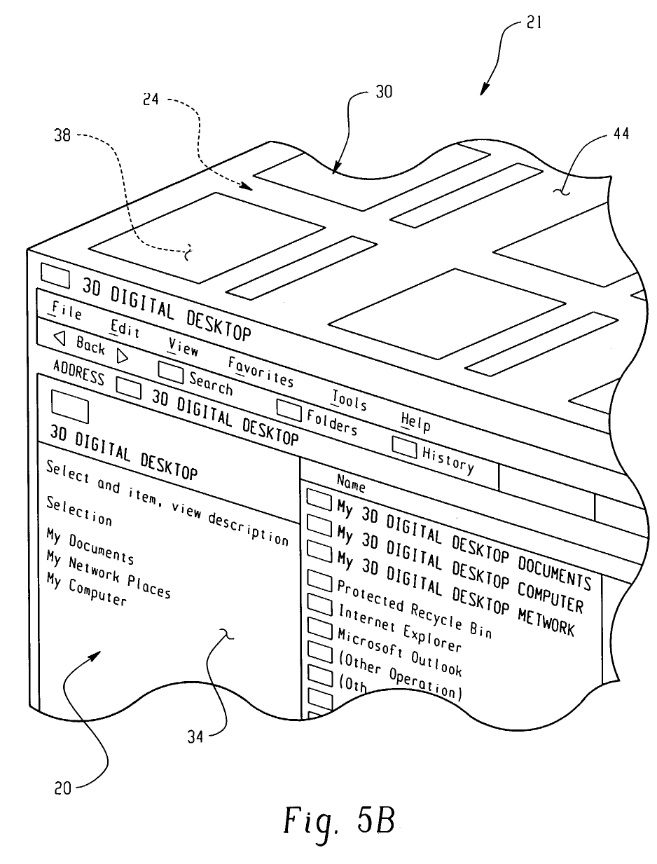

Turning now to FIGS. 5A and 5B, a texture mapped cube 21 is displayed. Each side of the cube 21 has a unique surface display, or texture map. From the angle shown in FIG. 5A and with an opaque texture mapped side, three displays are visible simultaneously. It is also within the scope of the present invention to provide translucent sides such that all 6, or 12 if both faces are utilized, displays are visibly accessible to a user. In the presently preferred embodiment, the translucency of the cube 21 permits the user to view a greater number of cube faces (i.e., windows) simultaneously. When all six windows are translucent, the user can see all of the icons at once. Icons on faces of the cube which are seen through other faces suitably appear laterally inverted, i.e. mirrored; this inversion allows the user to more easily perceive the orientation of the cube. Preferably, when a user selects a window, it becomes opaque so that it is more easily viewable.

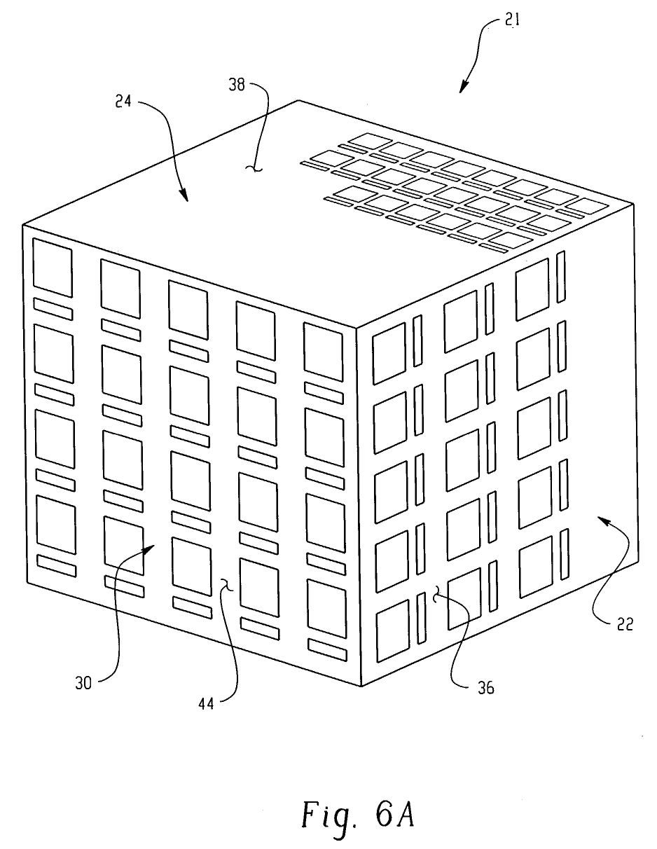

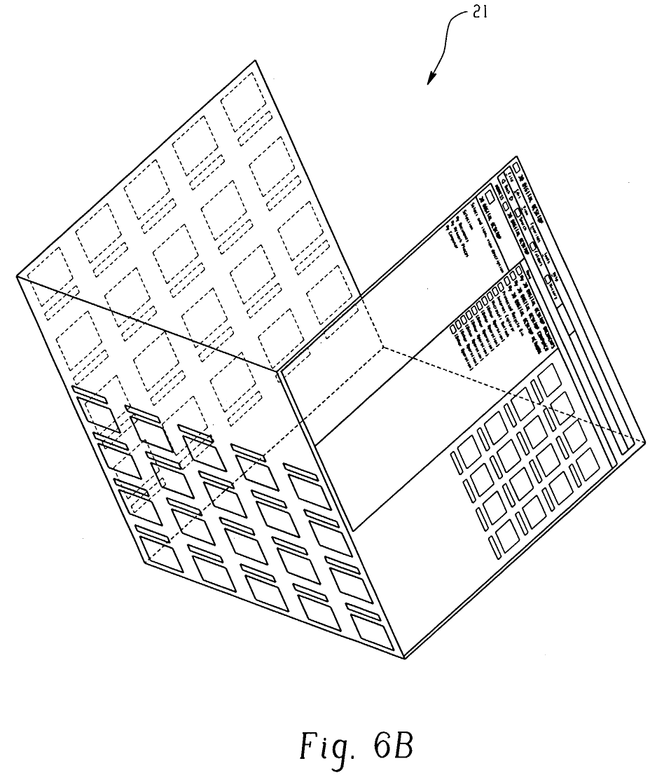

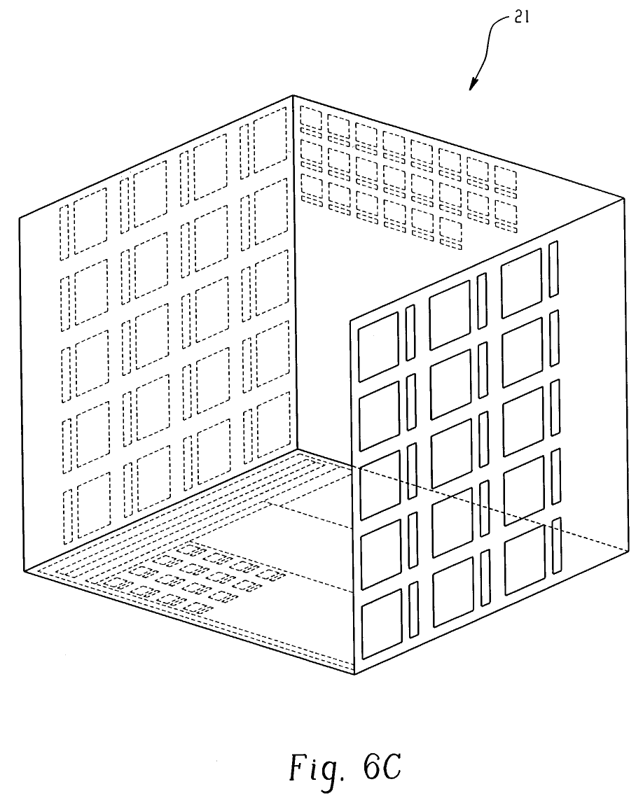

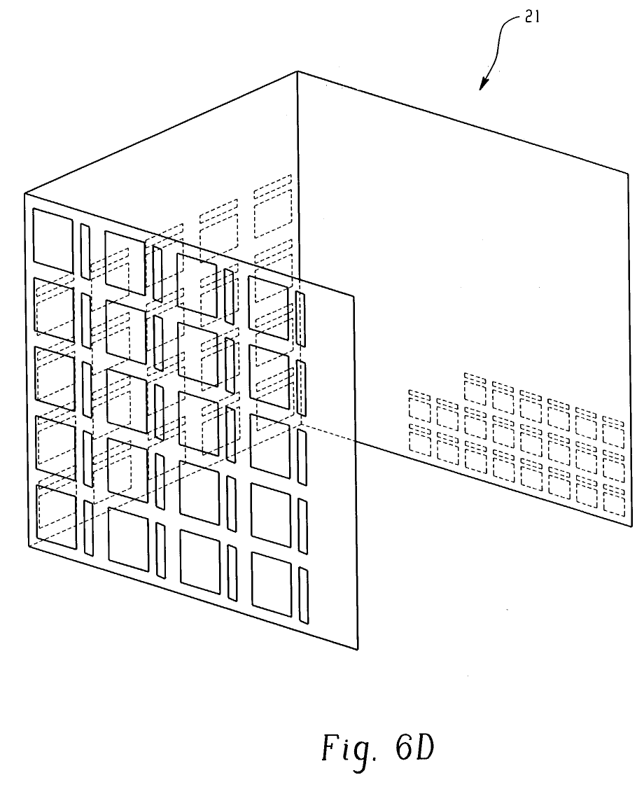

Turning now to FIGS. 6A through 6D, various views of a NURB cube 21 of a preferred embodiment of the present invention are displayed. Preferably, the cube 21 suitably rotates about at least one axis in any one of at least three modes: (1) constantly rotation, (2) user controlled rotation or (3) both. In the presently preferred embodiment, the cube 21 has a default rotation pattern such that each face of the cube is displayed as normal to the user's line of sight once during each rotation cycle. Both the rotation speed and rotation patter are suitably controlled by the user.

In the presently preferred embodiment, the three dimensional cube suitable works in conjunction with the GUI software. Therefore, the cube suitably interacts with programs and operating systems including but not limited to Microsoft Windows OSs, Linux OSs, Mactintosh OSs, an Unix OSs. In addition, the cube suitably functions with software such as Java 3D, Open GL, Active X or the like. In the presently preferred embodiment, the cube 21 is formed by a user such that the user selects which icons or windows to display on each side of the cube. The selection is suitably accomplished through drop-down menus or the like. When a user selects to form a cube, the GUI suitably causes the desktop to shrink away from the user to reveal a cube. The user then suitably selects default images and/or windows such that the images are displayed on the faces of the cube when it is first formed. In essence, each side of the cube suitably acts like the desktop of a computer. Once one or more windows is mapped onto the cube, the user suitably selects a window. In response, the selected window then becomes opaque. If the user wishes to edit a window, the user suitably removes a window from the cube and edits it as one would a standard, two-dimensional window. Once edited, the window is suitably re-applied to the cube.

The user suitably selects any viewpoint from which to display the cube, including viewpoints from inside of the cube. As a result, the cube is scalable. The user also suitably controls both the rotation and orientation of the cube. The user suitably selects to view the cube at any face of any side and at any axis. There are no restrictions on the cube display other than those created by the limit on sides in a three-dimensional object.

One exemplary view of the cube is an axis view in which one axis orthogonal to each side of the cube, are displayed. Control points are also suitably provided at regular intervals along the axes to enable the user to grab and drag the cube to achieve a desire orientation. Because the cube works in conjunction with current OSs, a user has an option to return to a standard desktop at any time by resetting or turning the cube off. In such instances, the cube disappears, the desktop rises to fill the screen, and any windows that were mapped to the cube reappear on the desktop.

In addition, the present invention is limited to the shape of a cube, nor is it limited to displaying only one geometrical shape. In another embodiment of the present invention, a user suitably elects to have more than one cube displayed simultaneously, permitting an even greater number of windows to be displayed. Each cube may therefore be minimized so that it is represented by a small, cube icon. Preferably, the icon spins.

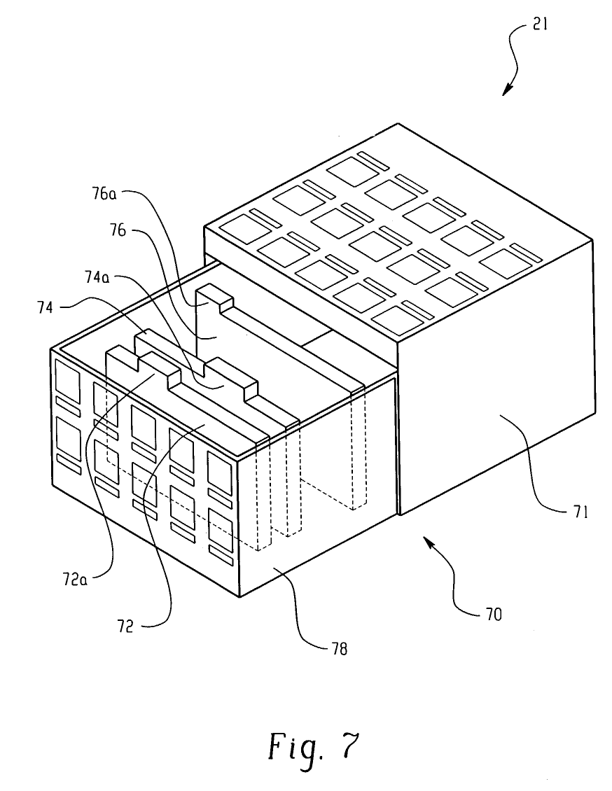

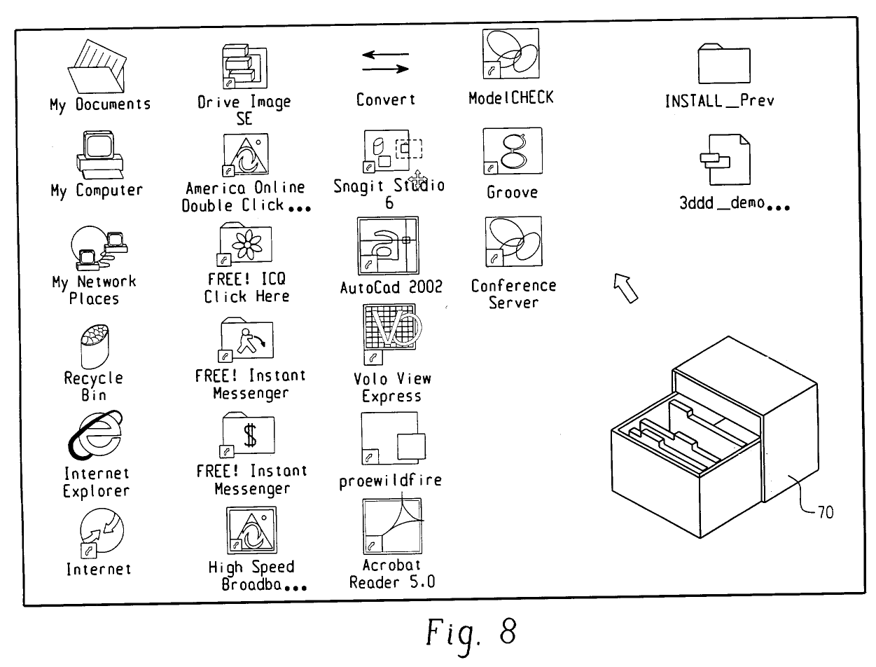

Referring now to FIG. 7, there is shown a three dimensional (3D) file cabinet 70 as contemplated by the present invention. A user may associate a plurality of documents, programs, applets, or other objects to an icon or applet and store them in the 3D File cabinet 70. Like a typical office filing cabinet, the 3D file cabinet comprises a frame 71 and a drawer 78. The 3D file cabinet 70 is displayed when the user selects either an icon or applet from the desktop or cube 21 that has documents, programs, or objects associated. The 3D File cabinet 70 functions as a sub-menu. The 3D File cabinet 70 opens a drawer 78, within the drawer is are documents 72, 74 and 76. The documents have tabs 72a, 74a and 76a for displaying data about documents 72, 74 and respectively, allowing a user to easily determine the contents of each document. FIG. 8 shows the 3D File cabinet 70 superimposed over a planer surface. The location of the 3D File cabinet 70, whether covering a surface of cube 21, or located elsewhere on the display is unimportant.

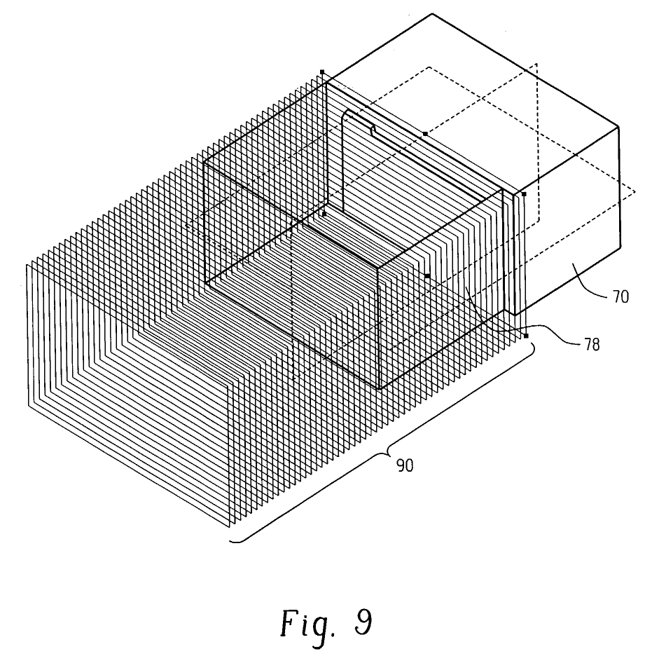

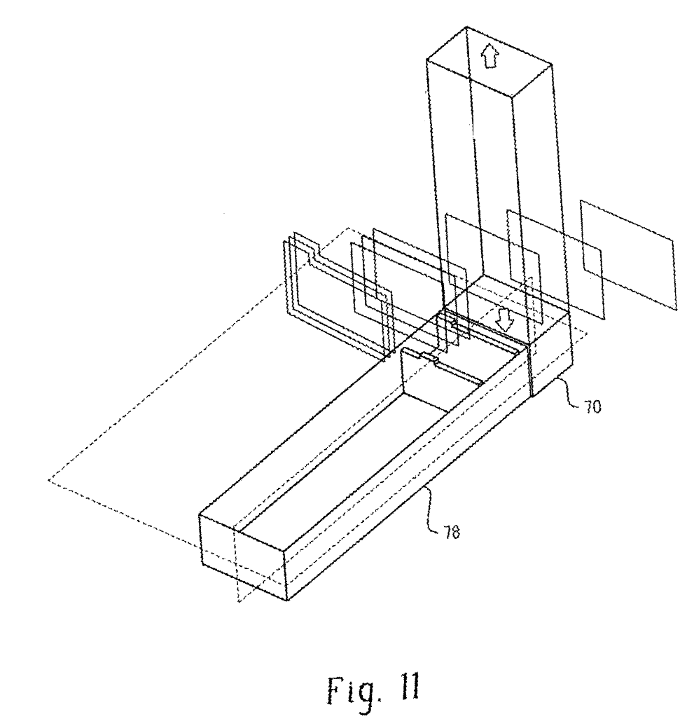

Referring now to FIG. 9, there is shown the 3D file cabinet 70 with a large number of documents 90 extending beyond the length of the drawer 78. As those skilled in the art can readily appreciate, as the 3D file cabinet 70 is virtual as opposed to being a truly physical filing cabinet, more documents 90 may be placed in the drawer 78 than would normally be physically realizable. Similarly, the drawer 78 can actually be larger than the frame 70 as shown in FIG. 11. Scroll bars (not shown) or other means may be used to scroll through the documents 90.

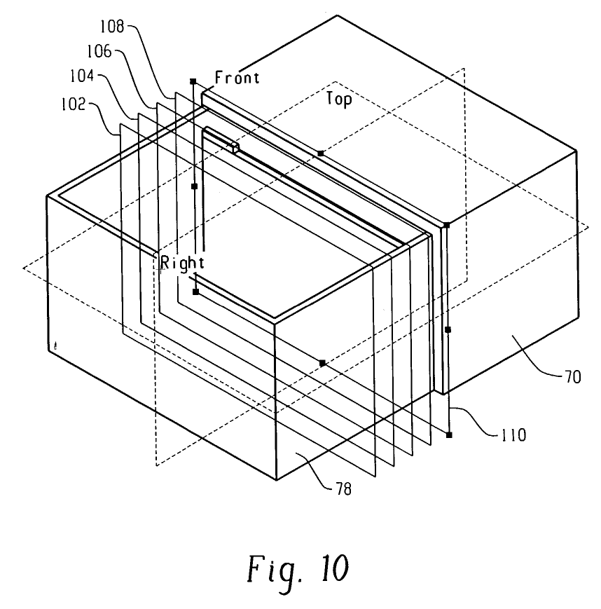

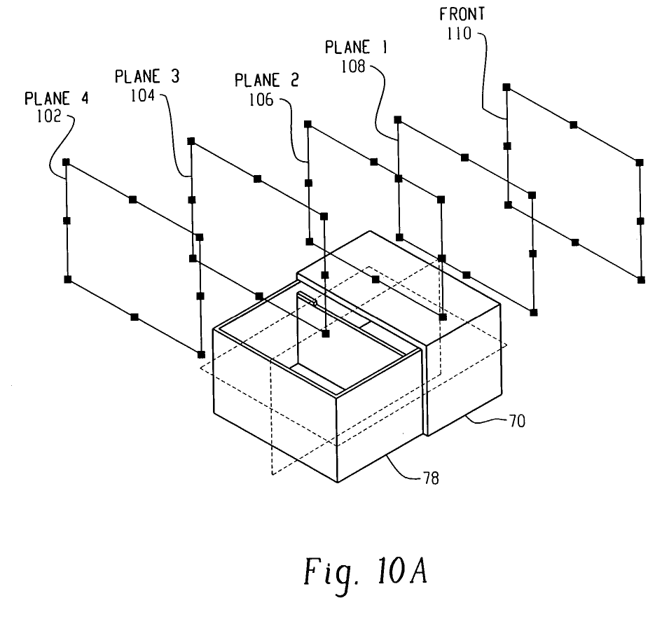

Referring now to FIGS. 10 and 10a, there is shown the virtual filing cabinet with a plurality of planes 102, 104, 106, 108 and 110. Each plane 102, 104, 106, 108 and 110 maybe used to store a document and by using input means such as a mouse, the planes may be moved outside of the 3D File cabinet 70 by standard dragging techniques to view additional details which may be stored on the document.

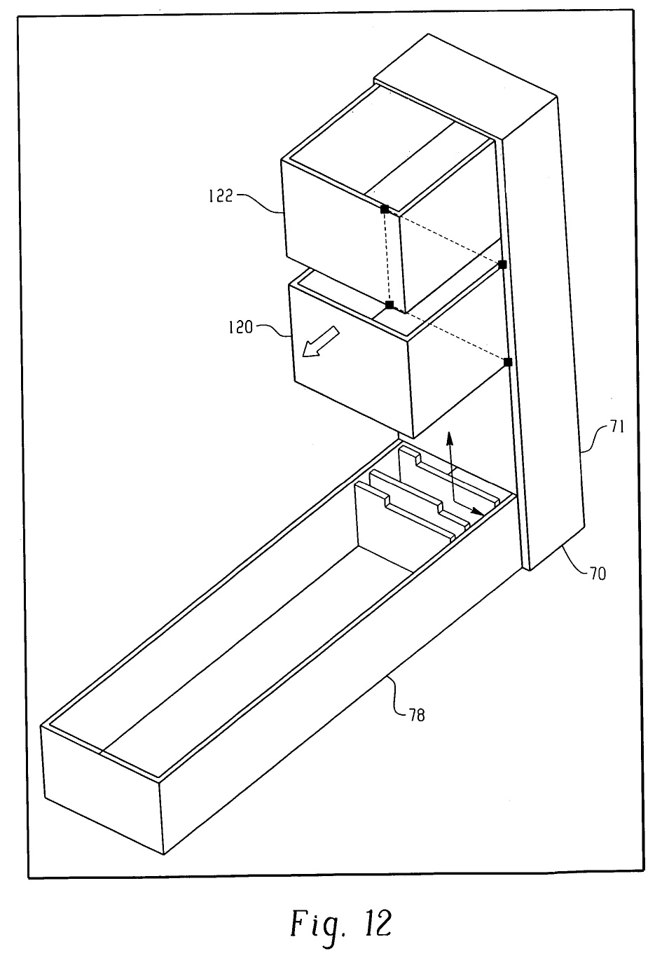

Referring now to FIG. 12, there is shown a 3D filing cabinet 70 with three open drawers 78, 120 and 122. It should be noted that all of these drawers, 78, 120 and 122 are longer than the cabinet 70. This arrangement may be convenient when more than one type of document or class of documents are linked to a particular icon or applet. For example, reports may be stored in the cabinet 70 by month wherein each of the drawers 78, 120 and 122 represent a different month's report. As another example, Microsoft Word style sheets, documents, and add-ins may be stored in the drawers 78, 120 and 122 respectively.

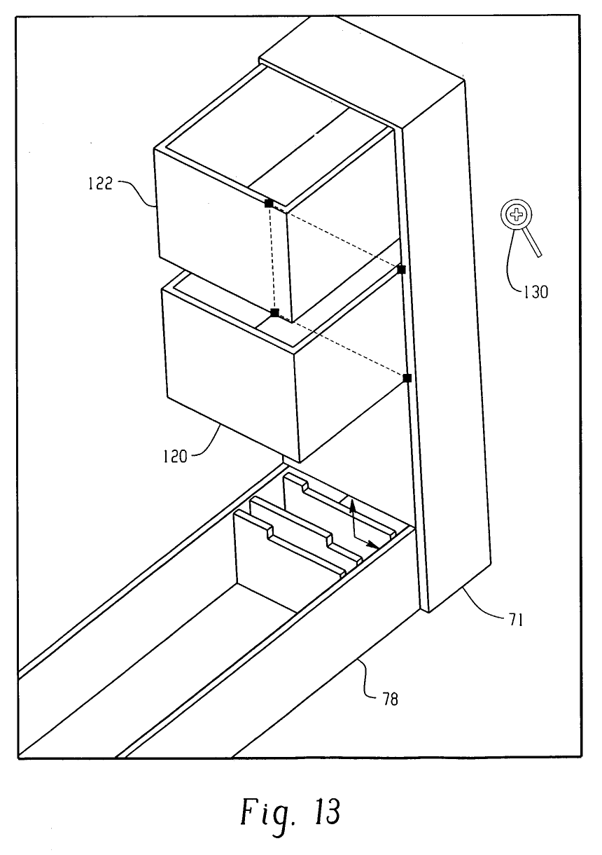

Referring now to FIG. 13, there is shown a 3D filing cabinet 70 with a lock 130. A user may lock one of the drawers 78, 120, 122 by selecting the key icon 130 and dragging it to one of the drawers 78, 120, 122. The process would further include prompting the user for a password. Access to the protected drawer thereafter would require the password. Thus the 3D filing cabinet 70, like a standard office filing cabinet can be locked.

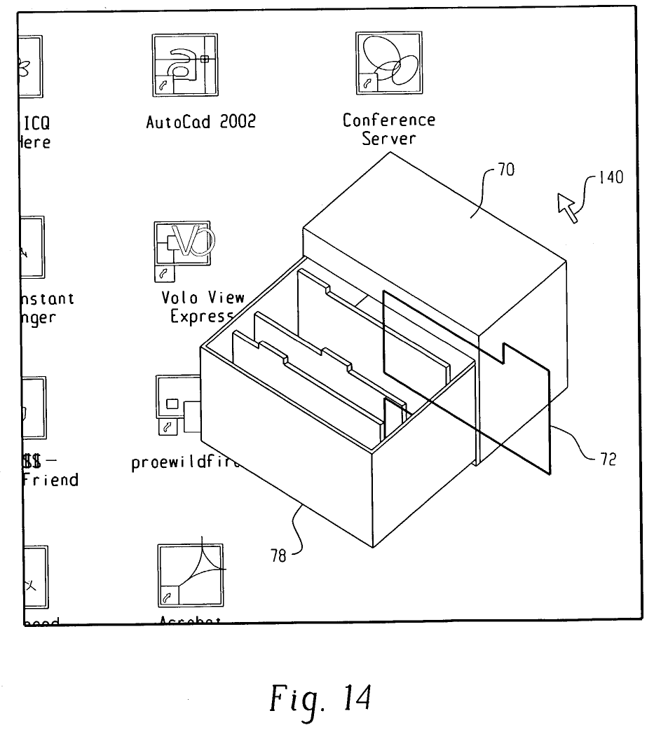

As shown in FIG. 14, a document 72 may be moved outside of the drawer 78. The document may be moved by using a mouse icon 140, or other GUI input means to select and drag the document 72.

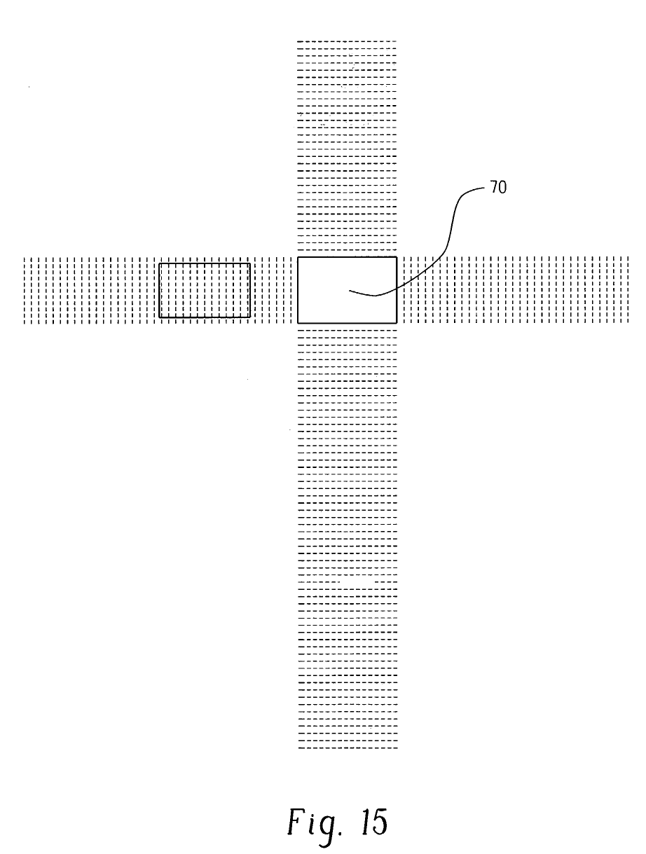

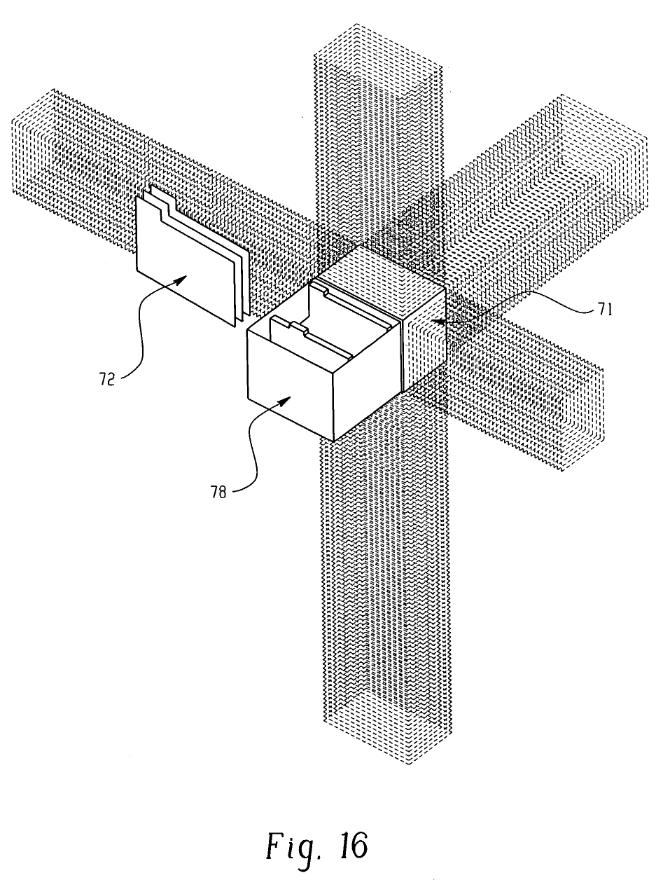

Referring now to FIGS. 15 and 16, there is shown a 3D filing cabinet 70 wherein documents may be dragged along the x, y and z axis. For the cubed shaped 3D filing cabinet 70 shown, documents may be displayed along any one of the six surfaces. Furthermore, a NURB cube with an icon or applet on each of the six surfaces may be used instead of a 3D cabinet.

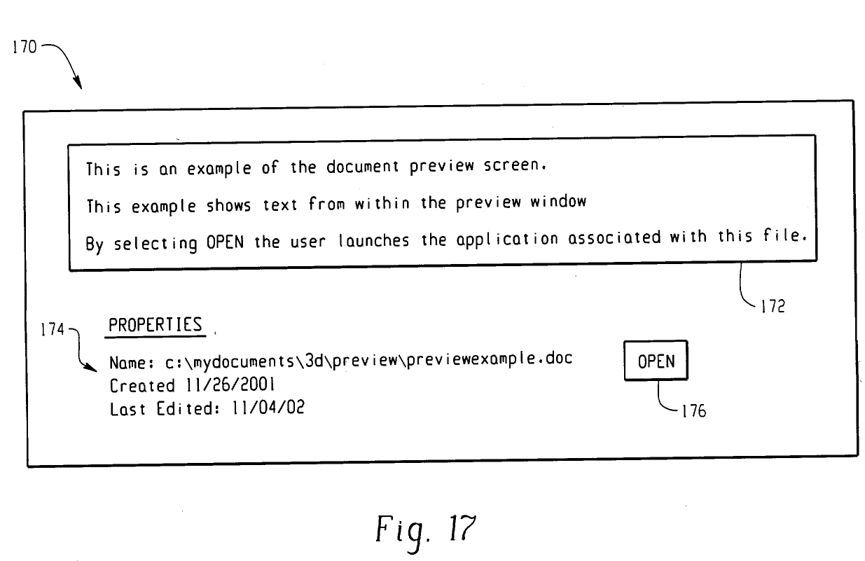

Referring now to FIG. 17, there is shown an example of a document displayed in a preview window 170. The preview window 170 in this example has three sections. The first section of the preview window 170 is the view window 172 which shows the contents of the document. The properties section 174 of the preview window 170 is used to display properties about the document. A button 176, is provided to enable a user to open the document. By selecting button 176, the preview window 170 launches the application associated with the document.

Further features and advantages of the present invention as well as the structure and operation of various embodiments of the present invention are described in detail below with reference to the accompanying drawings. In the drawings, like reference numbers indicate identical or functionally similar elements. Additionally, the left-most digit of a reference number identifies the drawing in which the reference number first appears. When documents are selected or dragged from the 3D filing cabinet 70, they may be displayed on a preview page (not shown). The preview page would typically contain a front page or icon of the document, and

While various embodiments of the present invention have been described above, it should be understood that they have been presented by way of example, and not limitation. It will be apparent to persons skilled in the relevant art that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A graphical user interface system for simultaneously displaying a plurality of windows, comprising:
a plurality of Non-uniform Rational B-Splines surface planes, each surface plane having a window texture mapped thereon; and
display means for displaying said surface planes at respective orientations.

2. The system of claim 1 wherein the Non-uniform Rational B-Splines surface planes form a three dimensional display object.

3. The system of claim 1 further comprising input means for receiving user input causing said display means to display more than one of said surfaces simultaneously.

4. The system of claim 1 wherein the three dimensional display object is a cube.

5. The system of claim 1 further comprising control means for rotating the a Non-uniform Rational B-Splines surface planes in response to a user input via said control means.

6. The system of claim 1 wherein at least one of the windows is translucent.

7. The system of claim 1 further comprising at least one of the group consisting of an icon and an applet mapped to a one of the plurality of surface planes.

8. The system of claim 7 further comprising means for displaying a plurality of objects in a three dimensional file cabinet, said three dimensional file cabinet displayed when an object is selected from one of the plurality of surface planes, said object one of the group consisting an icon and an applet.

9. The system of claim 8 wherein the three dimensional file cabinet further comprises a representation of a document, wherein selection of the representation causes the document to be displayed in a preview window.

10. The system of claim 9 wherein the preview window further comprises means for launching an application associated with said document.

11. A graphical user interface system for simultaneously displaying a plurality of windows, comprising:
a plurality of Non-uniform Rational B-Splines surface planes, each surface plane having a window texture mapped thereon, wherein the Non-uniform Rational B-Splines surface planes form a three dimensional display object;
display means for displaying said surface planes at respective orientations;
input means for receiving user input and causing said display means to display more than one of said windows simultaneously; and
control means for rotating the a Non-uniform Rational B-Splines surface planes in response to a user input via said input means.

12. The system of claim 11 wherein the three dimensional display object is a cube.

13. The system of claim 12 wherein at least one of the windows is translucent.

14. The system of claim 13 further comprising at least one of the group consisting of an icon and an applet mapped to a one of the plurality of surface planes.

15. The system of claim 14 further comprising means for displaying a plurality of objects in a three dimensional file cabinet, said three dimensional file cabinet displayed when an object is selected from one of the plurality of surface planes, said object one of the group consisting an icon and an applet.

16. The system of claim 15 wherein the three dimensional file cabinet further comprises a representation of a document, wherein selection of the representation causes the document to be displayed in a preview window.

17. The system of claim 16 wherein the preview window further comprises means for launching an application associated with said document.

18. The system of claim 17 further comprising means for locking a drawer of the three dimensional filing cabinet.

19. A computer-readable medium of instructions, comprising:
means for creating a plurality of Non-uniform Rational B-Splines surface planes, each surface plane having a window texture mapped thereon; and
means for displaying said surface planes at respective orientations.

20. The instructions of claim 19 further comprising means for the Non-uniform Rational B-Splines surface planes to form a three dimensional display object.

21. The instructions of claim 19 further comprising means for receiving user input and causing said means for displaying to display more than one of said surfaces simultaneously.

22. The instructions of claim 19 further comprising means for rotating the plurality of Non-uniform Rational B-Splines surface planes in response to a user input.

23. The instructions of claim 19 further comprising instructions for creating at least one of the group consisting of an icon and an applet mapped to a one of the plurality of surface planes.

24. The instructions of claim 23 further comprising means for displaying a plurality of objects in a three dimensional File cabinet, said three dimensional File cabinet displayed when an object is selected from one of the plurality of surface planes, said object one of the group consisting an icon and an applet.

25. The instructions of claim 24 wherein the three dimensional File cabinet further comprises means for displaying a representation of a document, wherein selection of the representation causes the document to be displayed in a preview window.

26. The instructions of claim 25 wherein the preview window further comprises means for launching an application associated with said document.

27. A method for displaying icons on a graphical user interface comprising the steps of:
texture mapping a plurality of windows to a plurality of Non-uniform Rational B-Splines surface planes; and
displaying said surface planes at respective orientations.

28. The method of claim 27 further comprising orientating the Non-uniform Rational B-Splines surface planes to form a three dimensional display object.

29. The method of claim 27 further comprising
receiving user input; and
responding to said user input by displaying more than one of said surfaces simultaneously.

30. The method of claim 27 further comprising orientating the Non-uniform Rational B-Splines surface planes to form a cube.

31. The method of claim 27 further comprising rotating the a Non-uniform Rational B-Splines surface planes in response to a user input.

32. The method of claim 27 further comprising mapping at least one of the group consisting of an icon and an applet mapped to a one of the plurality of surface planes.

33. The method of claim 32 displaying a plurality of objects in a three dimensional file cabinet, said three dimensional file cabinet displayed when an object is selected from one of the plurality of surface planes, wherein said object is one of the group consisting an icon and an applet.

34. The method of claim 33 further comprising displaying a representation of a document, wherein selection of the representation causes the document to be displayed in a preview window.

35. The method of claim 34 further comprising launching an application associated with said document by selecting an icon from the preview window.
